(19) United States
(12) Patent Application Publication
(10) Pub. No.: US 2004/0098332 A1
(43) Pub. Date: May 20, 2004

(54) Method of sales and marketing primarily involving catalogue advertising, sealed bidding type auctions

(76) Inventor: Haim Dvir, Tenafly, NJ (US)

Correspondence Address: Michael P. Kenney, c/o Amster, Rothstein & Ebenstein, 90 Park Avenue, New York, NY, 10025, US

(21) Appl. No.: 10/295,377

(22) Filed: Nov. 15, 2002

(51) Int. Cl. G06F 17/60

(52) U.S. Cl. 705/37

(57) ABSTRACT

A method of sales and marketing involving the combination of print catalogues, online catalogues and communication, a sealed bid auction format, telemarketing and creation of revenue streams. The combination of known prior art techniques with some lesser known and some completely novel sales and marketing techniques creates numerous synergies and paths to alternative sales and marketing options. The methods result in novel revenue streams, large amounts of marketing data and a new sales outlet for distributors/manufacturers which is very attractive to them for numerous reasons not the least of which is greatly increased sales with no deleterious effect on the value of their brand, i.e. brand devaluation. All of the methods disclosed begin with a catalogue/online offering for auction of various items and the conducting of a sealed bid auction for a specified period of time regarding these items.

### BACKGROUND OF THE INVENTION

The primary goal of any sales and marketing effort is to create and sustain interest in consumer goods among consumers and to convert this interest into sales. Many effective ways of achieving this goal exist.

Sales by catalogue have been in existence for almost as long as it has been economically feasibly to print catalogues and get them into the hands of consumers. Catalogues have typically been used for both remote sales, e.g. delivery by mail, and to entice the customer to visit a store carrying the goods in the catalogue. In recent decades, catalogue sales have been the primary non-storefront sales technique. The primary justification of incurring the cost of providing numerous prospective customers with free catalogues is the fact that people often like to look at things that they might wish to buy from a catalogue at their own convenience, from both a timing viewpoint and a location viewpoint. That is, providing a catalogue to a customer gives that customer the ability to review consumer goods at whatever time and in whatever place that customer may choose. Whatever the reasons and results, it can be taken as simply an established marketing and sales fact that many customers like to look at catalogues.

One of the most important aspects of any type of sales and marketing strategy which involve catalogues as an essential ingredient is effective distribution of the catalogue. The importance of getting a catalogue into the hands of the ‘right’ customers cannot be underestimated. The ‘right’ customer is, of course, the customer most likely to purchase items from the catalogue in question. There are many options available to a party wishing to distribute catalogues, ranging from the broadest methods such as bulk distribution to highly specific and directed mailings to people most likely to be prospective customers. Additionally, how much time and money it is possibe to invest in determining who these ‘most likely prospective customers’ are, can be essentially limitless. As with anything else, the amount it would be prudent to invested would be a function of the possible reward.

A relatively new type of marketing/sales outlet has often been referred to as “E-Shopping”. That is, a retailer markets goods and services to prospective customers via the Internet and some or all of the review and sales portion of the transaction are accomplished over a connection through the Internet. Typically, this transaction is completed by way of delivery of the purchased item to the customer. This marketing and sales technique is analogous to a catalogue type sales outlet.

The auctioning of goods is far older than almost any other sales or marketing technique utilized today. In the millennia that auctions have taken place, numerous iterations of how such auctions can be conducted have been utilized by various sellers and buyers. These various auctioning techniques have typically been tailored to best fit the needs and desires of both the sellers and the buyers. The seller involved in a typical auction has the initial purpose of enticing as many bidders as possible to view the auctioned item in a good light and the ultimate purpose of receiving the highest bid from the bidders.

Telemarketing is the use of a telephone to reach prospective consumers of goods or services and to market these goods or services to that customer. Though certainly not as old as auctions and catalogue sales, telemarketing is certainly familiar to all people living in a consumer society. This familiarity may be the result of its use in a harassing manner by a small minority of telemarketers. The bad reputation earned by the small minority of telemarketers over the last several decades has resulted in a certain backlash against the industry. This backlash is expected to increase as technologies such as automated dialing of prospective customers are implemented by irresponsible telemarketers.

Spending money marketing goods or services to customers who do not need or want the product and never will, is simply a waste of money. The higher the ratio of persons reached through any marketing strategy who actually purchase the marketed item, the higher the marginal profit and the higher the net profit will be. Thus, the availability of information regarding the buying habits of a large pool of consumers and the proper utilization of that information can be the difference between a large profit and a large loss. As with just about any sales and marketing strategy, telemarketing and catalogue distribution depend primarily upon information to be successful.

### SUMMARY OF THE INVENTION

The present invention relates to methods involving unique combinations of many aspects of sales and marketing. The combination of known prior art techniques with some lesser known and some completely novel sales and marketing techniques creates numerous synergies and paths to alternative sales and marketing options. The methods involve numerous aspects of catalogue marketing (both traditional and online), sealed bid auction-type sales, telephone sales people, online bidding and economically advantageous media channels. The methods result in novel revenue streams, huge amounts of marketing data collected on consumers participating in the sealed bid auction and a new sales outlet for distributors/manufacturers which is very attractive to them for numerous reasons not the least of which is greatly increased sales with no deleterious effect on the value of their brand, i.e. brand devaluation.

The method according to the present invention comprises a marketing and sales technique for making a specific number of a single product available to prospective customers to place bids on. By specific number of a single product, it is meant that each of the items is identical to the others. Each product is made available through the use of a catalogue distributed in such a way as to maximize participation among the parties who receive the catalogue. A customer may place bids on items contained in the catalogue either telephonically or by electronic means (email, online, etc.). Bidders for items are not made aware of other pending bids, i.e. this is a sealed bid type auction. Bidders may place more than one bid, but a fee per bid is usually applied. Upon the expiration of the time limit set for that particular auction in question, a determination is made as to the highest bidders, i.e. if ten identical items are offered the top ten bidders will receive the item.

The above method is amenable to many different variations regarding the details. The catalogues may be traditional catalogues or online accessible catalogues. The bidding fee arrangement may be altered in many ways, for example special promotional products may be offered for a much reduced or free bidding fee. Another example would reward customer loyalty with preferred (i.e. reduced) bidding fees. The manner in which bids are placed is also open to such options as a dial-in number or online.

More importantly, the above marketing and sales method can be supplemented by various telemarketing techniques at any point. These telemarketing strategies may involve the most basic “cold-call”, but this is typically avoided except where there is unused telemarketing capacity. More preferably, the supplemental telemarketing techniques used in the general method is directed telemarketing. That is, although calls are placed from the call center, these calls are directed at parties who have a previous relationship to the auction.

A preferred embodiment of the sales and marketing method presented herein would utilize the vast amounts of information collected regarding the consumer needs of the auction participants. These auction participants, whether they win or lose, have provided a great deal of insight into what consumer products they are interested in buying. In addition, these insights may be extrapolated to products which the customer may not be actively seeking, but may be of interest to that customer.

Also a preferred embodiment of the methods presented herein, the party handling the auction and the customer are not the only parties to benefit. The supplier of the goods or services auctioned may benefit directly and indirectly in many ways. The methods discussed herein provide a new and unique exposure, i.e. a new media channel, for the goods or services of the supplier. The goods or services made available for auction by the supplier may be products which the supplier needs to sell immediately, for whatever reason. This method provides a way to reduce stock of items without adversely affecting the brand which the supplier has great interest in maintaining. Additionally, the supplier can acquire information from the auction manager to assist in their own sales and marketing efforts, including the bidding information.

### DETAILED DESCRIPTION OF THE PREFERRED EMBODIMENT

Some terms that will be used in this description:

Auctioneer—The Auctioneer in the party conducting the auction, primarily responsible for offering goods and services for bid, accepting bids including all information needed for a completion of a transaction and, finally, is ultimately responsible for assuring eventual delivery of goods and services to the winning bidders. More than likely, but not necessarily, the Auctioneer is also the party who will organize many preparatory and peripheral aspects of the auction including publication of the catalogue, management of the call center, handling of most sales and marketing matters related to the catalogue and auction, and dealing with suppliers and manufacturers of the goods and services.

Item—An Item is anything that can be auctioned. Typically the Item will be a consumer good or service.

Prospective Customer—A Prospective Customer is any party which may need or desire any of the Items contained in a catalogue.

Bidder—A bidder is a Prospective Customer who has actually submitted a bid to the Auctioneer.

Supplier—Typically, the Auctioneer will never actually be in possession of the Item. Rather, once the winning Bidders have been decided the Auctioneer will inform the Supplier or the Suppliers agents where to have the Item delivered.

The method of the present invention begins with the preparation of a catalogue. This catalogue, whether an actual printed publication or an electronic catalogue, is a collection of Items made available by the Auctioneer for bidding in the auction. Each of these Items is presented in the catalogue as a catalogue entry. Typically, an Item will occupy a single page of the catalogue, a half-page of the catalogue or a quarter-page of the catalogue. Lesser divisions may be utilized, but these divisions would be the most typical.

Whether a page in the catalogue is offering a single Item, two Items, four Items or any other number of Items, portions of that page can be made available to the Supplier. The Supplier may be charged a fee for pages in the catalogue, with different fees for placement of the page. That is, as with all types of advertising and marketing publishing certain pages, e.g. the back cover or inside back cover, will have certain value. This value is based almost completely on the likelihood of a Prospective Customer actually seeing that page. Suppliers may also be charged for portions of a page and be given special rates for multiple pages. A Supplier will often be associated exclusively with a single brand-name and that brand-name can figure more prominently if an entire page or group of pages are purchased by a Supplier. Besides the obvious income stream to the Auctioneer, such an arrangement would provide certain advertising benefits to the Supplier. The new media outlet of the Auctioneer's catalogue would be relatively cheap, since it is probably not the primary revenue stream for the auctioneer. As with any media outlet, the relative benefit thereof would depend upon cost and the amount of exposure provided. Viewed in this light, it would be a particular bargain for the Supplier. Also, as the circulation of the catalogue increases, the fee charged the supplier will also increase, based on the greater visibility of the catalogue as a media outlet.

Once the Suppliers have committed Items to be presented in the catalogue, the next step is to print the catalogue. The layout of the catalogue can take many forms, but for the purposes of the auctioning process for which the catalogue is to be used, there exist some important elements. A picture of the Item and a description thereof is typically provided. Along with this basic information, the Prospective Customer usually needs to be made aware of some information related to the auction process. This information includes the quantity of an offered Item, the minimum bid price for the Item, the retail price for the item, the fee charged the Bidder per bid and any ancillary charges, such as a delivery charge. The quantity of the Item defines the number of that Item which will be awarded to the successful high Bidders at the end of the auction period. No bid under the minimum bid price will be accepted. The quantity of the Item offered is decided in conjunction with the Supplier. Other information that the catalogue will likely need to contain is contact information so that a Bidder can place a bid, and a section regarding the rules of the auction and instructions on how to participate.

Having done all the preparation for the upcoming auction, the printed catalogue is distributed in the days or weeks just prior to the auction period. As with the directed distribution and mass distribution of any type of catalogue, much time and money is expended in the determinations of both the directed distribution, i.e. the mailing list, as well as the mass distribution. The mailing list, of Prospective Customers who are to receive their catalogues in their mail boxes, can be culled from many typical direct marketing sources. The most important of these direct marketing sources will be well maintained lists of Bidders in past auctions. As to mass distribution, consideration of the most cost effective of the many distribution channels is of primary importance. Cost effective will mean, of course, the highest likelihood of any one catalogue being reviewed by a Prospective Customer and eventual Bidder. Supplemental to the direct marketing and mass distribution via media outlets, advertising is utilized by the Auctioneer. This advertising can take any form including billboards, television/radio spots, online advertising and newspaper/magazine advertising.

Many of the auction steps involve either telephonic communications or online communications between agents for the Auctioneer and either Prospective Customers or Bidders. The agents for the Auctioneer (hereinafter “Agents”) will have many duties throughout the entire method of this invention. Typically, temporary help can be utilized in this regard. However, depending upon the frequency with which auctions are conducted, i.e. new catalogues are sent out, Agents may be kept consistently busy and therefore be permanent employees. In addition, computers may be utilized for many of the steps of the method which, until recently, would have required an Agent for cost effectiveness. Thus, Agents will mean any entity capable of interacting with Prospective Customers and Bidders.

The first duty, again prior to the actual commencement of the auction, of the Agents is assisting in getting the catalogue into the hands of Prospective Customers likely to become Bidders. Much of this duty involves responding to requests for catalogues made by Prospective Customers. Also during this pre-auction time period, Agents can be used to call previous Bidders or others to conduct survey and market research, or to otherwise increase awareness and participation in the upcoming auction.

Catalogues are distributed bearing a time period for the auction. A start date and an end date for the auction are clearly designated on any catalogue, webpage or advertisement for a particular auction. Typically, an auction will span approximately a week, and can very. This time period can be referred to as a bidding cycle, i.e. during this time period a Bidder may communicate a bid to the Auctioneer.

The bidding process is a key portion of the present method. There will typically exist certain constraints to bidding. First among these is that, usually, there will exist a minimum bid amount for each Item. If there is a minimum bid amount, no bids less than this threshold will be accepted. In addition, there will usually be a limit as to the number of bids that can be placed by a single bidder. For the majority of Items and Bidders, each bid will cost that bidder a nominal fee. By nominal it is meant that, compared to the value of the Item, the bid fee is a small percentage or fraction of a percentage. Usually, it is not possible to ‘change’ a bid. To the extent that a Bidder's minimum number of bids has not as yet been reached, the Bidder is certainly welcome to submit another bid and pay another bid fee. This later bid is, however, in addition to the earlier bid. If a Bidder wishes to withdraw a bid, an additional bid cancellation fee will also typically apply. Each bid accepted for a certain Item will receive an identification number and the Bidder will be made aware of the identification numbers of each of their bids.

Agents accept bids from Bidders throughout the bidding cycle. However, it has been learned through experience with unrelated sales and marketing techniques involving a specific time period that the number of bids received on any given day of a bidding cycle varies considerably. After a rush at the beginning of a bidding cycle there is often a substantial lull during the middle time period of the bidding cycle. The bidding cycle will usually end with a flurry of phone calls placing bids. Whenever these slow bidding days occur it is important to keep the Agents busy with related sales and marketing activities. One way this is achieved is by having the Agents call catalogue recipients who had not responded but had participated in previous auctions. Many other telemarketing activities related to the auction may be undertaken by the Agents, including even cold-calling consumers to introduce them to the auction.

The auction process utilized is often referred to as a “sealed bid”auction format. No valid bid filed by any Bidder will be made known to anyone during the auction itself. Rather, all of the information relevant to each valid bid is recorded, ‘sealed’and put to the side. Only after the expiration of the bidding cycle will the sealed bids for an Item be reviewed. This review may be handled by a party independent of the Auctioneer, e.g. an auditor, for the purpose of fostering faith in the integrity of the auction. Each of the sealed bids is reviewed and listed in order, from highest bid to lowest bid. Tie bids will be placed in the order in which they were received, earlier bids being placed higher on the list. The ordered list of bids is then compared to the number of Items that were made available in the catalogue. The number of Items is compared to the ordered list of bidders, and each Bidder is awarded an Item until there are no more Items remaining.

After compilation of the list of winning bidders, a call is placed to each of the winning bidders congratulating them. These telephone calls are referred to a “happy calls”. In addition, lists of the identification numbers of each of the winning bids will be published in various places, e.g. newspapers and on a web site. Publication of winning bids is secondary to the telephone call and other methods with regard to notifying the winning Bidders. A more important function of the publication of lists of winning identification numbers is to increase excitement for future auctions. This increased interest and excitement regarding upcoming auctions should be sought to be as broad as possible, i.e. not only among past Bidders but people not yet familiar with the auction process.

Items are delivered to the winning Bidders upon confirmation of payment. The majority of Items are shipped directly from the warehouses of the Supplier. Quick delivery of Items to the winning Bidder is considered an important aspect of the auction process and should be completed within a week of the closing of the auction. The savings to the Auctioneer by not maintaining inventory will be substantial.

There exists the possibility that a winning Bidder will refuse delivery of the Item. A part of the rules of the auction, printed in the catalogue and subject to which all Bids are accepted by the Auctioneer, every Bidder agrees to pay a penalty if their's is a successful bid but they are unable or unwilling to accept delivery of the Item. This penalty can be a fixed fee or a percentage of the Bidder's bid.

Thus, completes the full auction cycle. From organization of Suppliers and Items to actually completion of all of the transactions between Auctioneer and Bidder through receipt of the Item won. This however, is merely the beginning of the sales and marketing effort. As a result of all of the processes of each step of the auction discussed above, a large amount of data relative to a large amount of Prospective Customers and Bidders has been collected. Depending on how it is sorted and utilized, this data could be hugely valuable to the Auctioneer, to the Suppliers and to other parties.

One aspect of the interaction between Auctioneer and the Prospective Customers/Bidders needs to be stressed at this point. An important aspect of one embodiment of the method presented herein is that many of the telephone calls between the Auctioneer and the Prospective Customers/Bidders were placed by the Prospective Customer/Bidder. That is, although some phone calls (solicited and unsolicited) may be placed by the Agents, the majority of the phone calls were placed by the Prospective Customer/Bidder. Thus, Prospective Customers/Bidders are calling the Auctioneer and voluntarily providing the Agents with very valuable information regarding their wants and needs as consumers. This process can be referred to as reverse telemarketing. It is believed that a Prospective Customer who places the initial call will be much more likely to provide a large amount of information of value to sales and marketing concerns, including the Auctioneer and the Suppliers. In addition, it is also believed to be true that a consumer who receives a telephone call or other solicitation from the Auctioneer's Agents will be much more amenable to the sales and marketing efforts presented if the consumer had placed the telephone call the initiated the relationship between the two.

After completion of the auction, and distribution of Items to the winning Bidders, there is left for each Item a list of unsuccessful Bidders. This list of unsuccessful Bidders is already in the order of what those unsuccessful Bidders were willing to pay for a certain Item. This list can be utilized in many ways. Each of the Bidders may be called and offered the Item which they originally placed a bid for a set amount of money. Perhaps this second offer of the Item will be approximately what was initially offered by the Bidder. More likely, this second offer price will be slightly more. Additionally or alternatively, this unsuccessful Bidder may be offered an Item similar to the one initially bid on but slightly less expensive. Again, a large amount of information is available as to how much this Bidder was willing to pay for a similar Item as well as how much other Bidders were willing to pay. Setting of an offer price by the Auctioneer for the alternate Item can be informed thereby.

Another use for the compiled sales and marketing information is for goods and services which are not similar to the Item(s) bid on by various Bidders, but rather are related to the Item(s) which that Bidder is interested in. A Bidder that is interested in purchasing a car may also be interested in purchasing auto insurance; a Bidder who places a bid on a home computer would be much more likely than an average consumer to be interested in a printer/fax/scanner or perhaps an Internet service provider; a Bidder who places a bid on a HDTV system may be interested in a DVD player. Obviously, the options are virtually endless, and each of these options are made more effective from a sales and marketing standpoint based on the information collected before, during and after the auction.

Thus, there are many uses to which the information collected relative to the above method can be utilized by the Auctioneer. Not the least of these is a very large head-start with regard to Prospective Customer's for the next auction, the planning of which is usually nearing completion around the time of the completion of the present auction bidding cycle. In addition, the offering of the same Item or similar Item to unsuccessful Bidders and the offering of related Item(s) to both winning Bidders and unsuccessful Bidders does not need to be limited to the Auctioneer. Many Suppliers and prospective Suppliers would be interested in exactly the type of information that is being compiled through the method discussed disclosed herein. The value of this information can be realized in many ways offering an additional revenue stream resulting from this sales and marketing information.

The infrastructure of the auction method disclosed above can be utilized in myriad ways to create similar revenue streams from various sources. The term infrastructure, in its broadest sense, means the telemarketing center, the Agents, the Supplier network, an Internet homepage and the collected sales and marketing information. Smaller auctions may be held during ‘downtime’ between full-scale catalogue driven auctions. These smaller auctions may utilize other assets, the Internet homepage for example, as a starting point. Certain Items, perhaps closeout Items or excess inventory, may be offered only on the homepage for sealed bidding auctions lasting only a couple of days. These smaller auctions have a plurality of positive results for the Auctioneer. Relations with Suppliers are nurtured when Items the Supplier really wants to liquidate are disposed of quickly and effectively. Excitement is sustained among regular customers as well as new Prospective Customers between catalogue driven auctions. Capital expenditures for the call center everything else related to the business are reduced through an additional income stream during downtime.

Returning to the cornerstone of the auction process, i.e. the catalogue, it is in the best interest of the Auctioneer if Prospective Customers look at a catalogue. To the extent that a catalogue is not immediately looked at by a Prospective Customer, it is in the best interest of the Auctioneer if the Prospective Customer keeps the catalogue, i.e. does not dispose of the catalogue. A method of increasing the likelihood that a Prospective Customer will not dispose of a catalogue and actually picks-up the catalogue and looks at the products therein has been devised. Each catalogue issued through whatever channel, direct mail or mass distribution, bears a serial number unique to that catalogue and that particular auction. Displayed explicitly somewhere on or in the catalogue is the fact that a contest will be held at the end of the auction to which that catalogue pertains. The contest will involve the unique serial number printed on the catalogue. A person in possession of a catalogue bearing a serial number published on or about the last day of the auction will be awarded a certain valuable prize. Thus, not only is there incentive to keep the catalogue on-hand, there is also one more incentive to pay attention to the contents of the catalogue.

The Suppliers in the present method are able to realize some very specific benefits for a very modest investment. Included among the pool of possible Suppliers are manufacturers of consumer goods. These manufacturers, more so than many of the retailers, e-tailers and others, through whom they sell products and services to consumers, have very specific marketing and sales needs. Many of these needs are dictated by the fact that the manufacturer is usually the owner of the trademark/brand name under which its products are sold. In addition, it is a simple fact of retail economics that the closer a manufacturer is to a consumer in the sales chain, the more profit can be realized by the manufacturer. These facts are also related to special problems presented to a manufacturer as supplier. A manufacturer's relationship with its suppliers in a sales chain are very important to the manufacturer and damage to these relationships could result from a manufacturer directly supplying products to customers. In addition, perceptions of a brand name can be adversely affected by a manufacturer directly offering sales to the public at reduced prices. Regarding these and many other considerations of manufacturers and Suppliers, it is an important aspect of the auction method disclosed herein that these considerations be dealt with. Usually, these considerations can be best dealt with by instituting strict confidentiality agreements with the Suppliers. Under no circumstances will the Auctioneer release any Supplier information without the permission of the Supplier. Among the many other benefits realized from this type of Supplier confidentiality is the prevention of damage to a brand, i.e. sales can be made by a Supplier (including a manufacturer) at a low enough price to reduce inventory without having a damaging effect of the brand in question.

I claim:

1. A method for conducting an auction, comprising
a. organizing availability from a supplier of a certain number of essentially identical items to be auctioned;
b. making available to prospective customers relevant information regarding the auction items;
c. receiving, for a specific time period having a particular starting date and ending date, bids from bidders for the auction items;
d. sealing the bids after receipt thereof by maintaining all bids in secrecy;
e. unsealing the bids after the ending date;
f. placing the unsealed bids in order, high bid to low bid; and
g. matching the certain number of identical items to the ordered list of bids such that the highest bids are awarded the auction items.

2. The method of conducting an auction according to claim 1, further comprising the step of:
a. collecting a fee for each bid placed on each auction item.

3. The method of conducting an auction according to claim 1, further comprising the step of:
a. collecting a bid cancellation fee for each bid placed by a bidder that is later withdrawn by that bidder.

4. The method of conducting an auction according to claim 1, further comprising the step of:
a. charging the supplier a fee for offering an item to be supplied to the bidder.

5. The method of conducting an auction according to claim 1, further comprising the step of:
a. assigning each bid an identification number; and
b. publishing the identification numbers of the highest bids that are to be awarded the auction items.

6. The method of conducting an auction according to claim 1, further comprising the step of:
a. calling bidders that were not awarded auction items; and
b. offering the bidders not awarded auction items similar items for a price close to their original bid price.

7. The method of conducting an auction according to claim 1, further comprising the step of:
a. calling bidders after the auction items are awarded and offering items related to the auction item on which that bidder placed a bid.

8. The method of conducting an auction according to claim 1, further comprising the step of:
a. shipping the item directly from the supplier to each bidder who submitted one of the highest bids.

9. The method of conducting an auction according to claim 1, wherein:
a. the information is made available to prospective customers by way of an online catalogue.

10. The method of conducting an auction according to claim 1, wherein:
a. the information is made available to prospective customers by way of a print catalogue.

11. The method of conducting an auction according to claim _, wherein:
a. providing each print catalogue with a serial number unique to that catalogue; and
b. awarding prizes to the holder of certain catalogues.

12. The method of conducting an auction according to claim 1, wherein:
a. the information made available to prospective customers includes a picture of the item and a description of the item.

13. The method of conducting an auction according to claim 1, wherein:
a. the information made available to prospective customers includes a typical retail price for the item.

14. The method of conducting an auction according to claim 1, wherein:
a. the information made available to prospective customers includes a minimum bid price below which bids will not be received for an item.

15. The method of conducting an auction according to claim 1, wherein:
a. the information made available to prospective customers includes a maximum number of bids any one particular bidder is allowed to place on a the auction item.

16. The method of conducting an auction according to claim 1, wherein:
a. The information is made available to prospective customers based on marketing and sales information collected in previous auctions.

17. The method of conducting an auction according to claim 1, further comprising the step of:
a. collecting sales and marketing information regarding all bidders.

18. The method of conducting an auction according to claim 17, further comprising the step of:
a. utilizing the sales and marketing information regarding bidders in future auctions.

19. The method of conducting an auction according to claim 17, further comprising the step of:
a. selling the sales and marketing information regarding bidders to a third party.

20. A method of sales and marketing comprising:
a. conducting a sealed bid auction by way of mass circulation of print catalogues containing a plurality of items to be auctioned and then receiving sealed bids from bidders over a particular time period having a certain starting date and certain ending date;
b. collecting marketing and sales information on the bidders in the sealed bid auction;
c. utilizing the collected information in later sealed bid auctions; and
d. utilizing the collected information in a direct marketing of related items which the bidder may be interested in.

21. The method of sales and marketing according to claim 20 further comprising:
a. selling the collected information to other sales and marketing concerns.

22. The method of sales and marketing according to claim 20 further comprising:
a. collecting fees from bidders for participation in the sealed bid auction.

23. The method of sales and marketing according to claim 20 further comprising:
a. grouping information collected on bidders into logical categories such that other items that may be of interest to the bidder can be marketed to the bidder;
b. selling the grouped information to other sales and marketing concerns.

24. The method of sales and marketing according to claim 20 wherein:
a. a fee is charged to a supplier of items for placement of the suppliers item in the catalogue.

25. The method of sales and marketing according to claim 20 wherein:
a. auctioned items are shipped directly from the supplier to the bidder.
